(19) United States
(12) Patent Application Publication
(10) Pub. No.: US 2023/0017741 A1
(43) Pub. Date: Jan. 19, 2023

(54) THERAPEUTIC BLANKET

(71) Applicant: Gabrielle Westbrook, Irving, TX (US)

(72) Inventor: Gabrielle Westbrook, Irving, TX (US)

(21) Appl. No.: 17/851,115

(22) Filed: Jun. 28, 2022

Related U.S. Application Data
(60) Provisional application No. 63/217,316, filed on Jul. 1, 2021.

(51) Int. Cl. A47G 9/02; B41N 10/04

(52) U.S. Cl. CPC A47G 9/0223; B41N 10/04; A61M 2021/0022

(57) ABSTRACT

A two-layered therapeutic blanket for a user with sensory modulation difficulties includes a top layer and a bottom layer, operatively connected to the top layer. The top layer is constructed of a first fabric material having high stretch and elasticity. The bottom layer is constructed of a second fabric material that is resistant to body oils and perspiration. The second fabric material is static-free and elastic

### PRIORITY INFORMATION

The present application claims priority, under 35 U.S.C. § 119(e), from U.S. Provisional Patent Application Ser. No. 63/217,306, filed on Jul. 1, 2021. The entire content of U.S. Provisional Patent Application Ser. 63/217,306, filed on Jul. 1, 2021, is hereby incorporated by reference.

### BACKGROUND

Sensory processing refers to the way in which the brain receives, interprets, and responds to both external and internal sensory stimuli. Development of sensory integration typically begins at infancy through rolling, crawling, walking, playing, engaging with the environment and people within it, etc. However, for some individuals, the sensory system does not fully develop creating difficulties with sensory integration.

Sensory processing dysfunction occurs when a person demonstrates an increased difficulty integrating these neurological messages which could translate as an inappropriate response to sensory stimuli. When these ‘abnormal’ responses to sensory stimuli impact an individual's physical, social, and emotional wellbeing, or their ability to engage in everyday activities, a person may be considered to have a Sensory Processing Disorder.

However, not all children who experience difficulty processing sensory information have a Sensory Processing Disorder. For example, many children who are born with a neurodevelopmental condition, including but not limited to Autism Spectrum Disorder and Attention Deficit Hyperactivity Disorder, process sensory information differently than their typically developing peers.

In response to sensory information within their environment, an individual with sensory processing difficulties can generally be characterized as hypo (under) reactive or hyper (over) reactive. An individual, who is hypo reactive to sensory input, requires a higher level of input to elicit a response. On the other hand, an individual, who is hyper reactive, requires a minimal amount of sensory input to cause a reaction.

Individuals with sensory processing difficulties also tend to have trouble with self-regulation. Self-regulation is defined as: the process of noticing, organizing, and integrating information from the environment and the body, and then processing and responding appropriately. Individuals who have difficulty responding to sensory input have an increased likelihood of displaying internalized and externalized ‘problem’ behaviors, which could include aggression toward oneself or others, increased agitation, anxiety, and/or social withdrawal.

Our sensory system is comprised of eight sensations: vestibular, proprioception, interoception, tactile, sight, smell, taste, and hearing. The two sensations of concern are the proprioceptive and tactile systems.

The sense of proprioception allows the brain to be aware of the body in space and to plan movements to coordinate the body within each encountered environment. The receptors in the muscles, tendons, and joints tell the brain where the body parts are in space. This gives a person the ability to successfully complete movements, in regards to direction, speed, and force, to engage within a given environment with body parts without directly using the visual system.

Individuals who experience difficulty modulating their proprioceptive system may have trouble delegating how much force or speed is required to complete a given task. These individuals may look clumsy, uncoordinated, or demonstrate sensory seeking behaviors. Sensory seeking behaviors can often look inappropriate to others as these individuals are attempting to self-regulate by engaging in various behaviors.

These behaviors could include pushing, crashing, running, playing too rough, biting, chewing, writing too hard, shaking or kicking their legs while sitting, preferring tighter clothes, etc. Poor proprioceptive modulation can also present as poor motor planning or control, lack of body awareness, and/or poor postural control. The exhibited behaviors include difficulty going up and down the stairs, bumping into people or objects frequently, difficulty learning to ride a bike, slumping over while sitting in a chair, unable to stand on one foot, and/or the need to rest their head on their desk while working. Proprioceptive dysfunction can be demonstrated in a multitude of ways and it is important to be aware of these common signs.

The tactile system is the sense of touch. This is the system that communicates with the brain about what is in contact with the skin on the body. This information enables the understanding of whether that input is pain, pressure, or temperature, as well as allowing the discrimination of movement, size, and shape of an object coming in contact with the skin. The tactile system can then be categorized by two separate systems: defensive and discriminative.

The defensive system is what protects and alerts the body of potential harmful stimuli coming in contact with the skin (i.e., a mosquito landing on the skin). The discriminative system provides information about the physical nature of the object. This includes where on the body the sensation is coming from, temperature, and the pressure at which an object is touching the skin.

Challenges relating to sensory modulation of the tactile system occurs when the brain either over or under responds to this sensory information. Someone, who is hyper reactive or over responds to tactile input, might be very sensitive to textures or the fit of clothing, have difficulty in a crowd of people, or become irritated by light or unexpected touch. For example, someone may be very aware of the tag in the back of their clothes touching their skin. This can cause a person to be distracted by this sensation and potentially not be able to focus on anything else except for the way that this tag feels on their skin.

Comparatively, if someone, who is hypo reactive or under responsive to tactile input, might not be able to discriminate between textures, identify when clothes are askew on their body, or they might not notice someone tapping them on the shoulder, which could cause them to be more disconnected from others around them.

Conventionally, there are strategies to regulate the tactile and proprioceptive systems to allow individuals to participate in their everyday meaningful activities. Activities that send strong messages to the brain regarding the position of one's body can be very organizing for the nervous system. Input to one's joints or muscles can help an individual reach a level of alertness that can allow them to more readily focus, learn, and participate within their environment.

The sensorimotor cortex, which controls the proprioceptive system, is not fixed and therefore can be changed through external manipulations or strategies. Two strategies to regulate the proprioceptive and tactile system are heavy work and deep pressure. Heavy work, which involves heavy resistance and input to the muscles and joints, can bring an individual more awareness to their extremities, which gives feedback to their nervous system about where they are in space in relation to their environment.

Deep pressure is firm tactile sensory input that provides proprioceptive input to the entire body which can be very calming and organizing to the nervous system. Examples of deep pressure can include: firm hugs, firm squeezes, cuddling, hugging, compression, or swaddling.

One conventional method to address individuals, which have tactile and/or proprioceptive modulation difficulties, is to wrap the individual like a burrito in a blanket. Wrapping a person in a blanket can provide calming proprioceptive input to the entire body if wrapped up tight enough.

However, conventional blankets tend to cause the individual to become too hot, and therefore, the individual does not tolerate being wrapped up for a long period of time.

Moreover, the conventional blankets have differing textures which may not be easily tolerated by the tactile system.

Lastly, conventional blankets do not provide the individual with any compression. For the blanket to have enough of an effect on the nervous system, the individual would need to be wrapped as tight as they can tolerate.

Therefore, it is desirable to provide a blanket that imparts compression to an individual's body when wrapped like a burrito, thereby being beneficial to one's nervous system.

Also, it is desirable to provide a blanket that increases components of proprioceptive and tactile input, thereby benefiting one's ability to regulate their sensory system.

Thus, it is desirable to provide a blanket for an individual, which provides calming proprioceptive input to the entire body.

Furthermore, it is desirable to provide a blanket for an individual, which provides calming proprioceptive input to the entire body and does not overheat the individual.

Also, it is desirable to provide a blanket for an individual, which provides calming proprioceptive input to the entire body and does not have differing textures which may not be easily tolerated by the tactile system.

In addition, it is desirable to provide a compression-type blanket for an individual, which provides calming proprioceptive input to the entire body.

Moreover, it is desirable to provide a compression-type blanket for an individual, which provides calming proprioceptive input to the entire body and does not overheat the individual.

Additionally, it is desirable to provide a compression-type blanket for an individual, which provides calming proprioceptive input to the entire body and does not have differing textures which may not be easily tolerated by the tactile system.

Lastly, it is desirable to provide a compression-type blanket for an individual, which provides calming proprioceptive input to the entire body and does not have differing textures which may not be easily tolerated by the tactile system and does not overheat the individual.

### BRIEF DESCRIPTION OF THE DRAWINGS

The drawings are only for purposes of illustrating various embodiments and are not to be construed as limiting, wherein:

FIG. 1 illustrates a cut-away view of a two layered therapeutic blanket; and

FIG. 2 illustrates a top view of a two layered therapeutic blanket.

### DETAILED DESCRIPTION OF THE DRAWINGS

For a general understanding, reference is made to the drawings. It is noted that the drawings may not have been drawn to scale and that certain regions may have been purposely drawn disproportionately so that the features and concepts may be properly illustrated.

As noted above, conventional blankets tend to cause the individual to become too hot, and therefore, the individual does not tolerate being wrapped up for a long period of time. Moreover, the conventional blankets have differing textures which may not be easily tolerated by the tactile system. Lastly, conventional blankets do not provide the individual with any compression.

For a blanket to have enough of a therapeutic effect on the nervous system, the individual would need to be wrapped as tight as they can tolerate. Thus, a blanket that provided compression to the individual's body would be more beneficial to one's nervous system as it would increase the amount of proprioceptive and tactile input provided.

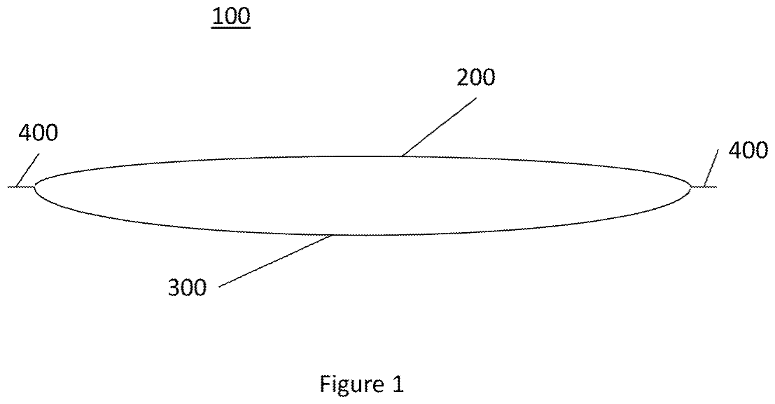

FIG. 1 illustrates a two-layered therapeutic blanket 100. As illustrated in FIG. 1, a top layer 200 is constructed of a fabric comprised of 85% polyester and 15% spandex. A bottom layer 300 is a fabric constructed of a fabric comprised of 82% nylon and 18% spandex. The bottom layer 300 is intended to be the layer that contacts an individual's body. The top layer 200 and the bottom layer 300 are bounded together by seam 400.

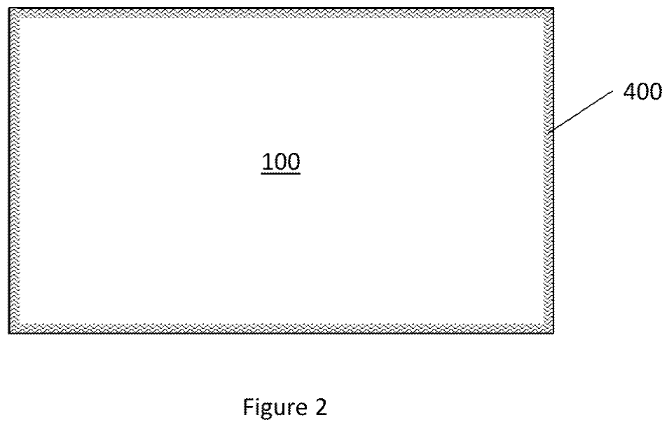

FIG. 2 illustrates a two-layered therapeutic blanket 100 with a seam 400. The seam 400 is constructed of a zig-zag stitch to connect the top layer 200 of FIG. 1 to the bottom layer 300 of FIG. 1 so as to not inhibit the elasticity of the two-layered therapeutic blanket 100. The zig-zag stitch of seam 400 moves as the two-layered therapeutic blanket 100 is stretched.

With respect to the bottom layer 300 of the therapeutic blanket 100, the combination of nylon and spandex creates a fabric that is extremely comfortable, lightweight, and resistant to body oils or perspiration, as well as abrasion resistant, pile, and static-free. The nylon and spandex construction provides elasticity, but nylon and spandex construction also enables the fabric to return to its original shape after being stretched, thereby keeping the integrity of the product intact.

The nylon and spandex construction of the bottom layer 300 has high tensile and compressive strength and a low coefficient of friction, thereby providing versatility. The nylon and spandex construction of the bottom layer 300 also permits the body to breathe, is moisture wicking, and allows for muscle expansion and contraction during movement.

With respect to the top layer 200 of the two-layered therapeutic blanket 100, the combination of polyester and spandex provides high stretch, elasticity, and comfort to the user. The polyester and spandex construction also retains its original shape after it is stretched.

The combination of the bottom layer 300 of the two-layered therapeutic blanket 100 and the top layer 200 of the two-layered therapeutic blanket 100 creates a therapeutic blanket that is soft to the touch and durable.

The combination of the bottom layer 300 of the two-layered therapeutic blanket 100 and the top layer 200 of the two-layered therapeutic blanket 100 also creates a therapeutic blanket that has a moisture wicking finish, a stretch component, is comfortable to wear, and allows for good lateral movement.

The two-layered therapeutic blanket 100 can be used by having the individual lie on the bottom layer 300 of the two-layered therapeutic blanket 100 (fabric that is 82% nylon and 18% spandex) so that the individual can be wrapped or rolled up as tightly as can be tolerated. The compression received from the two-layered therapeutic blanket 100 provides the individual with proprioceptive and tactile input that allows for immediate feedback to the nervous system.

The bottom layer 300 of the two-layered therapeutic blanket 100 elicits a majority of the compression to an individual's body as the individual is wrapped in the two-layered therapeutic blanket 100 because the nylon and spandex construction of the bottom layer 300 has the ability to resist tension and has strong compressive properties.

Moreover, the bottom layer 300 of the two-layered therapeutic blanket 100 is easily tolerated by individuals with tactile modulation difficulties as it is snag resistant and has a soft feel to it.

The top layer 200 of the two-layered therapeutic blanket 100 (fabric 85% polyester and 15% spandex) adds an additional compressive factor to the overall effect of the two-layered therapeutic blanket 100. This additional stretch, causing further compression, aids in the sensory regulation of the individual being wrapped in the blanket.

The top layer 200 of the two-layered therapeutic blanket 100 is easily tolerated by an individual with tactile modulation difficulties as it is soft to the touch.

Additionally, the combination of the bottom layer 300 of the two-layered therapeutic blanket 100 and the top layer 200 of the two-layered therapeutic blanket 100 has breathability and moisture wicking properties so as not to overheat the individual within the two-layered therapeutic blanket 100.

In summary, the two-layered therapeutic blanket 100, offers individuals, with sensory modulation difficulties in the areas of proprioception and tactile, the necessary compression needed to organize their nervous system.

A two-layered therapeutic blanket for a user with sensory modulation difficulties, comprises a top layer and a bottom layer, operatively connected to the top layer; the top layer being constructed of a first fabric material having high stretch and elasticity; the bottom layer being constructed of a second fabric material that is resistant to body oils and perspiration; the second fabric material being static-free and elastic.

The second fabric material may have a characteristic of being able to return to its original shape.

The first fabric material may be constructed of polyester and spandex.

The second fabric material may be constructed of nylon and spandex.

The first fabric material may be constructed of 85% polyester and 15% spandex.

The second fabric material may be constructed of 82% nylon and 18% spandex.

The two-layered therapeutic blanket may further comprise a zigzag stitch to connect the top layer to the bottom layer.

The first fabric material may be constructed of a compressive material.

The second fabric material may be constructed of a compressive material.

The second fabric material may have high tensile strength, compressive strength, and a low coefficient of friction.

The second fabric material may be breathable and moisture wicking.

The second fabric material may be snag resistant.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

1. A two-layered therapeutic blanket for a user with sensory modulation difficulties, comprising:
a top layer; and
a bottom layer, operatively connected to said top layer;
said top layer being constructed of a first fabric material, said first fabric material having high stretch and elasticity;
said bottom layer being constructed of a second fabric material, said second fabric material being resistant to body oils and perspiration;
said second fabric material being static-free and elastic.

2. The two-layered therapeutic blanket, as claimed in claim 1, wherein said first fabric material is constructed of polyester and spandex.

3. The two-layered therapeutic blanket, as claimed in claim 1, wherein said second fabric material is constructed of nylon and spandex.

4. The two-layered therapeutic blanket, as claimed in claim 2, wherein said second fabric material is constructed of nylon and spandex.

5. The two-layered therapeutic blanket, as claimed in claim 1, wherein said first fabric material is constructed of 85% polyester and 15% spandex.

6. The two-layered therapeutic blanket, as claimed in claim 1, wherein said second fabric material is constructed of 82% nylon and 18% spandex.

7. The two-layered therapeutic blanket, as claimed in claim 5, wherein said second fabric material is constructed of 82% nylon and 18% spandex.

8. The two-layered therapeutic blanket, as claimed in claim 1, further comprising:
a zigzag stitch to connect said top layer to said bottom layer.

9. The two-layered therapeutic blanket, as claimed in claim 1, wherein said first fabric material is constructed of a compressive material.

10. The two-layered therapeutic blanket, as claimed in claim 1, wherein said second fabric material is constructed of a compressive material.

11. The two-layered therapeutic blanket, as claimed in claim 9, wherein said second fabric material is constructed of a compressive material.

12. The two-layered therapeutic blanket, as claimed in claim 1, wherein said second fabric material has high tensile strength, compressive strength, and a low coefficient of friction.

13. The two-layered therapeutic blanket, as claimed in claim 1, wherein said second fabric material is breathable and moisture wicking.

14. The two-layered therapeutic blanket, as claimed in claim 1, wherein said second fabric material is snag resistant.

15. The two-layered therapeutic blanket, as claimed in claim 1, wherein said second fabric material has a characteristic of being able to return to its original shape.
